(19) United States
(12) Patent Application Publication
(10) Pub. No.: US 2026/0099573 A1
(43) Pub. Date: Apr. 9, 2026

(54) SMART DEPLOYMENT OF HONEYPOT ENVIRONMENT ON PERSONAL DEVICES

(71) Applicant: Kyndryl, Inc., New York, NY (US)

(72) Inventor: Cesar Augusto Rodriguez Bravo, Alajuela (CR)

(21) Appl. No.: 18/905,336

(22) Filed: Oct. 3, 2024

(51) Int. Cl. G06F 21/32

(52) U.S. Cl. CPC G06F 21/32

(57) ABSTRACT

Embodiments relate to smart deployment of a honeypot environment on personal devices for security. An aspect includes receiving an authentication request to access a device and determining that the authentication request is to initiate a security system on the device. An aspect includes, in response to initiating the security system, executing an artificial environment, appearing as a real environment, for presentation on the device, wherein the artificial environment is presented to exclude sensitive information of the real environment.

### BACKGROUND

The present invention generally relates to computer systems, and more specifically, to computer-implemented methods, computer systems, and computer program products configured and arranged to provide smart deployment of a honeypot environment on personal devices for security.

Mobile devices such as cell phones are ubiquitous today. Mobile device security is an evolving field, which includes safeguarding personal information stored on mobile devices and preventing unauthorized access or misuse. Mobile security may include practices like setting strong passwords or biometric locks, keeping device software updated, installing antivirus software, and being cautious when downloading applications or browsing the Internet. Additionally, mobile security includes physical threats to mobile devices, which most commonly refer to the loss or theft of a mobile device, because unauthorized users have direct access to the hardware where private data is stored.

### SUMMARY

Embodiments of the present invention are directed to computer-implemented methods for providing smart deployment of honeypot environment on personal devices for security. A non-limiting computer-implemented method includes receiving an authentication request to access a device and determining that the authentication request is to initiate a security system on the device. The method includes, in response to initiating the security system, executing an artificial environment, appearing as a real environment, for presentation on the device. The artificial environment is presented to exclude sensitive information of the real environment.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to dynamically provide smart deployment of an artificial/honeypot environment on a personal device for security while protecting real data of a real/normal environment according to one or more embodiments of the present invention;

FIG. 3 is a flowchart of a computer-implemented method for dynamically providing smart deployment of an artificial/honeypot environment on a personal device for security while protecting real data of a real/normal environment according to one or more embodiments of the present invention;

FIG. 4 depicts a block diagram of an example real/normal environment according to one or more embodiments of the present invention;

FIG. 5 depicts a block diagram of an example artificial/fake environment for security according to one or more embodiments of the present invention;

FIG. 6 is a flowchart of a computer-implemented method for providing smart deployment of an artificial/honeypot environment on a personal device for security while protecting real data of a real/normal environment according to one or more embodiments of the present invention;

FIG. 7 depicts a cloud computing environment according to one or more embodiments of the present invention; and

FIG. 8 depicts abstraction model layers according to one or more embodiments of the present invention.

### DETAILED DESCRIPTION

One or more embodiments are configured and arranged to execute a fake environment, such as a honeypot environment, once a given set of factors are achieved during an authentication process such as a biometric authentication process. To protect the information on an electronic device, a security system, such as a mobile security system, is activated once the electronic device detects the user initiation. To protect the content on and/or accessible by the electronic device, the security system generates and displays a fake environment for interaction by an unauthorized user on the electronic device. This allows the unauthorized user to perform actions in the fake environment and not the real environment, such that private and sensitive information is protected from access by the unauthorized user.

A honeypot is a cybersecurity mechanism that uses a manufactured attack target to lure cybercriminals away from legitimate targets. A honeypot can be modeled after any digital asset, including software applications, servers, or the network itself. The honeypot is intentionally and purposefully designed to visually appear as a legitimate target, resembling the model in terms of structure, components, and content. This is meant to convince the adversary that they have accessed the actual system. The honeypot serves as a decoy, distracting cybercriminals from actual targets.

With the ubiquitous use of electronic devices such as mobile devices, there are various scenarios in which an unauthorized user can gain physical access to the electronic device of a user. The unauthorized user represents anyone who is not authorized by the owner (user) to access or interact with the electronic device. The unauthorized user may be a cybercriminal, an attacker, etc. In some cases, the unauthorized user may force a user to unlock access to his/her personal electronic device. For example, a user may be forced to input authentication information including biometrics (e.g., fingerprint, face recognition, gait, etc.), passwords, gestures, etc., to gain access to the electronic device, where sensitive information is stored and accessible. The problem is that once the user inputs authentication information, the unauthorized user has full control over the device, over the information (data) stored on the device, and over communications to/from the device.

Accordingly, one or more embodiments provide a security system to prevent an unauthorized user from accessing sensitive user data even after authentication information has been input to access control of the electronic device. The unauthorized user appears to have full control over the device, but the unauthorized user does not have access to the sensitive information (data) stored on the device or to communications to/from the device. One or more embodiments provide a method and device for receiving an authentication request to access the device, determining that the authentication request is to initiate a mobile security system on the device, and in response to initiating the mobile security system, executing an artificial environment, appearing as a real environment, for presentation on the device. The artificial environment is presented to exclude sensitive information of the real environment.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

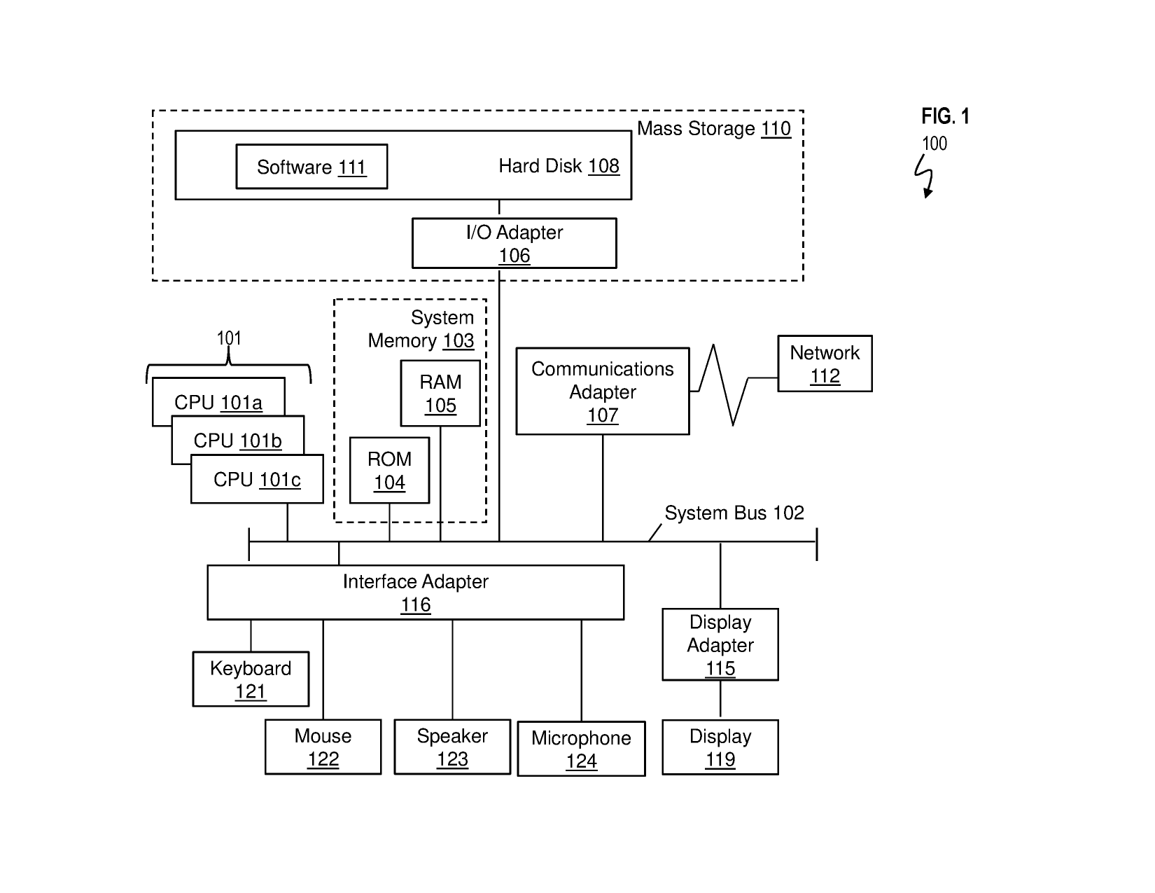

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

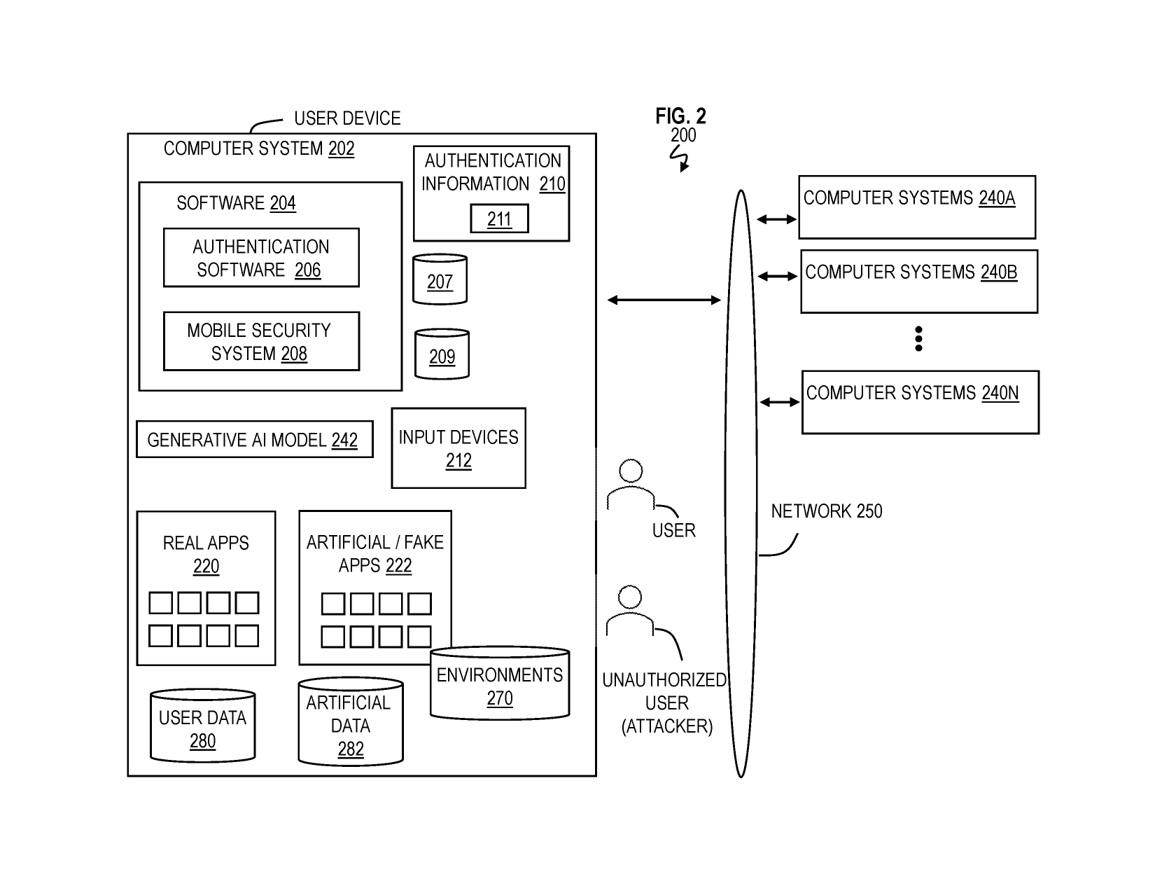

FIG. 2 depicts a block diagram of an example system 200 configured to dynamically provide smart deployment of an artificial/honeypot environment on a personal device for security while protecting real data of a real/normal environment, according to one or more embodiments. The system 200 includes a computer system 202 configured to communicate over a network 250 with many different computer systems, such as a computer system 240A, a computer system 240B, through a computer system 240N. The computer system 240A, the computer system 240B, through the computer system 240N can generally be referred to as computer systems 240. Once connected to the computer system 202, the computer systems 240 provide numerous online services as known to one of ordinary skill in the art. Online services refer to computer services and/or digital services provided over a network communication such as the network 250. Examples online services provided by the computer systems 240 may include banking services, social media services, crypto currency services, messaging services, work services (e.g., remote access to computer networks of employers), email services, music services, media streaming services, financial investment services, and the like.

The computer system 202 may be representative of an electronic device such as any type of personal user device. Although a single user device is illustrated in FIG. 2, the user device can represent numerous user devices connectable to the network 250. The user device can be a personal computer or laptop. The user device can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The computer system 202 can include various software and hardware components including software applications (apps) for communicating over the network 250 as understood by one of ordinary skill in the art.

The computer system 202, computer systems 240, software 204, generative AI model 242, authentication software 206, mobile security system 208 (e.g., software), etc., can include functionality and features of the computer system 100 in FIG. 1 including various hardware components and various software applications such as software 111 which can be executed as instructions on one or more processors 101 in order to perform actions according to one or more embodiments of the invention. The software 204, authentication software 206, mobile security system 208 can include, be integrated with, and/or call other pieces of software, algorithms, application programming interfaces (APIs), graphical user interfaces (GUIs) etc., to operate as discussed herein.

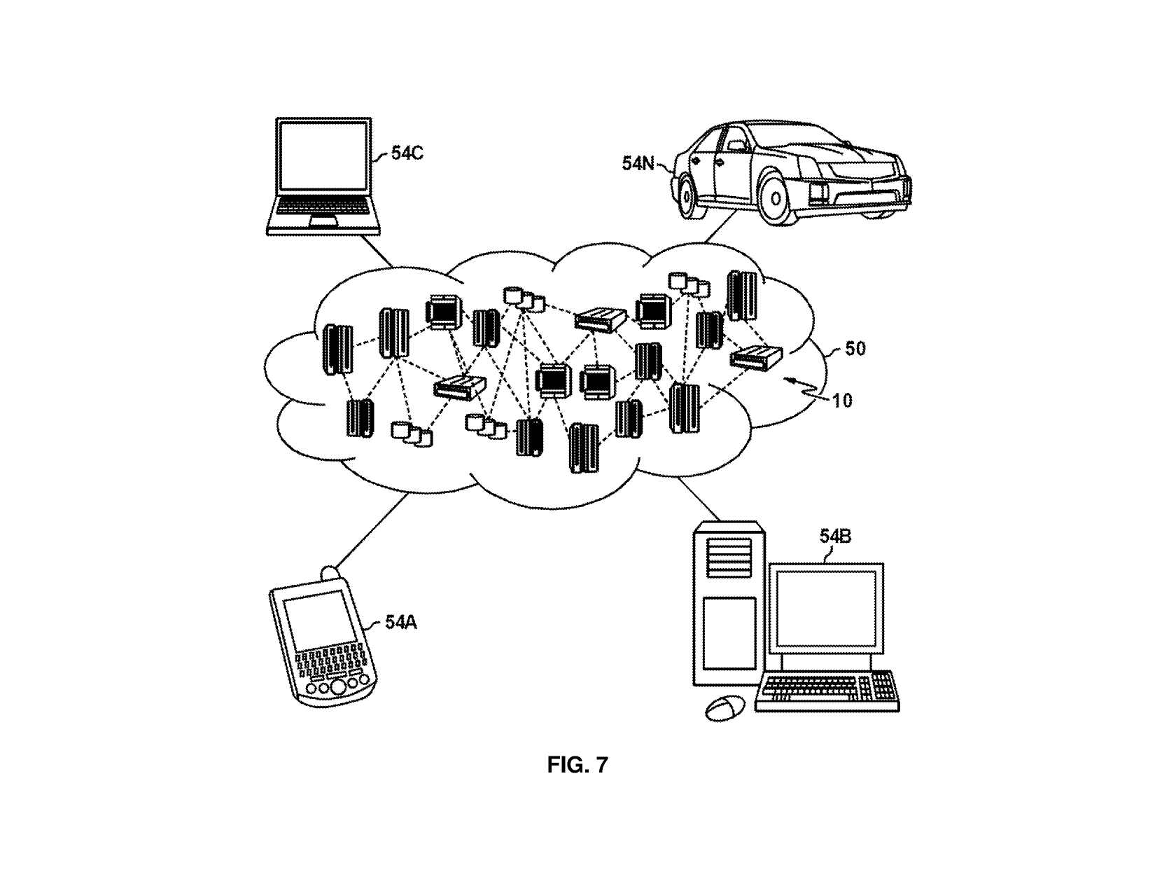

The computer system 202 may communicate with one or more computer systems in a cloud computing environment such as a cloud computing environment 50 depicted in FIG. 7, as discussed further herein. One or more of the computer systems 240A-240N may be in the cloud computing environment 50 and provide services to the computer system 202.

Generative AI engines/models use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. Generative AI is trained to learn human language, programming languages, art, chemistry, biology, or any complex subject matter. Generative AI reuses training data to solve new problems. For example, it can learn the English vocabulary and create a poem from the words it processes. An organization can use generative AI for various purposes. Like all artificial intelligence, generative AI works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as summarization, text generation, classification, open-ended conversation, and information extraction.

Small language models: A small language model (SLM) is a generative AI technology similar to a large language model (LLM) but with a significantly reduced size. In contrast to LLMs, SLMs have a smaller model size, enabling LLM-type capabilities but with fewer parameters and required resources. Small language models are commonly fine-tuned on domain-specific data sets. That specialization increases efficiency in targeted use cases. With their smaller size, these models are particularly effective on systems with limited computational resources, including mobile devices. SLMs are smaller, simpler, and more streamlined than LLMs, and they can be trained more quickly. Due to their smaller size, small language models can be trained and deployed much faster than larger models. The smaller size potentially reduces delays when processing requests.

The computer system 202 includes a generative AI model 242. Also, the computer system 202 may be connected to generative AI models hosted on any of the computer systems 240 to perform as discussed herein. In one or more embodiments, the generative AI model 242 can be based on an LLM. In one or more embodiments, the generative AI model 242 on the computer system 202 can be an SLM to provide a reduced footprint in terms of computer resources such as memory, processing power, input/output functionality, etc. The computer system 202 may install the generative AI model 242 from one of the computer systems 240.

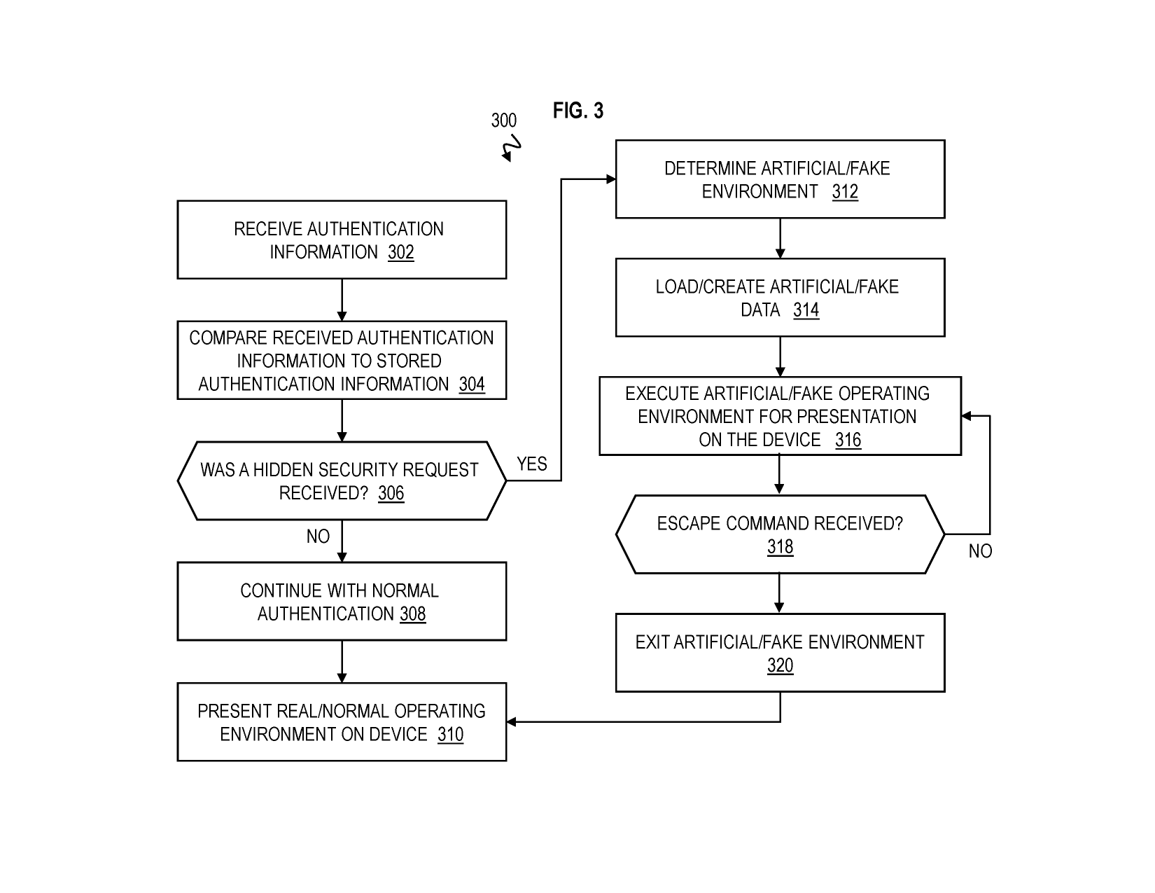

FIG. 3 depicts a flowchart of a computer-implemented method 300 for dynamically (in real-time or near real-time) executing smart deployment of an artificial/honeypot environment on a personal device for security while protecting real data of a real/normal environment according to one or more embodiments.

The computer-implemented method 300 can be executed by the computer system 202 which can represent any known personal or user device. An example scenario may be that the user is required or forced to allow access (e.g., unlock using credentials) to his/her user device in the presence of an unauthorized user (e.g., attacker). In accordance with one or more embodiments, a security system is in place to prevent the unauthorized user from accessing sensitive or personal information on the user, even though the user device has been unlocked. Although an example scenario is provided, it should be appreciated that the example scenario is for illustration purposes and is not meant to limit embodiments. Reference can be made to any figures discussed herein.

At block 302 of the computer-implemented method 300, the software 204 of computer system 202 is configured to receive and/or capture authentication information 210 of a user. There are many known methods for authentication including password-based authentication, biometric authentication, gesture-based authentication, etc., or any combination thereof. Password-based authentication is the most common method of authentication for securing a device. The “password” might be a username-password combination, passcode, personal identification number (PIN), etc. Biometric authentication uses unique physical attributes like facial recognition, iris/eye tracking, fingerprint scanning, gait tracking, voice recognition, etc., to identify a user. Gesture-based authentication may include drawing an unlock/lock pattern on a touch screen, hand movements including swipe gestures, etc.

At block 304, software 204 of the computer system 202 is configured to compare the received authentication information 210 to the stored authentication information. Various types of stored authentication information for the user can be stored in repository 207 to be compared and matched to the received authentication information 210 input to the computer system 202. Any known method can be utilized to check and compare the received authentication information 210 to the stored authentication information. In one or more embodiments, the software 204 may include, call, and/or employ authentication software 206 to perform the authentication. Authentication is the process of determining if the person or entity accessing a computing system is who they claim to be. Authentication systems make a binary decision in which they allow or deny access based on credentials or other proof provided by those requesting access. Typically, the user enters (e.g., types, scans, etc.) their credentials, such as a username and a password, biometrics, gestures, etc. The authentication system queries a user directory, such as the repository 207. If the credentials match, the user is allowed to access the computer system for normal operation.

At block 306, the software 204 of the computer system 202 is configured to check whether a hidden security request 211 was received as the authentication information 210 and/or as part of the authentication information 210 from the user in order to launch and execute a mobile security system 208. Various types of stored hidden security request information for the user can be stored in repository 209 to be compared and matched to the received authentication information 210 input to the computer system 202. The software 204 (and/or the authentication software 206) compares the received authentication information 210 against stored hidden security request information to determine if the hidden security request 211 is present in the authentication information 210.

The hidden security request 211 is considered hidden or unapparent to the unauthorized user (e.g., attacker) who may be viewing the user input his/her authentication information 210. Additionally, receipt of the hidden security request 211 does not cause the computer system 202 to visually display any indication that the hidden security request 211 is provided during the input of the authentication information 210. The hidden security request 211 is input using any technique including password-based authentication, biometric authentication, gesture-based authentication, etc., and combinations thereof.

There are numerous ways in which the user can input the hidden security request 211 of the authentication information 210. When biometric authentication is the input method of the authentication information 210, the hidden security request 211 can be determined by fingerprint recognition. For example, the user can use a different finger from the normal finger to launch the mobile security system 208, can move the finger in a particular manner/direction, can execute a given pressure over the reader for a given period of time (e.g., keep the finger on the sensor for a predetermined amount of second (e.g., 3 seconds)), etc.

When biometric authentication is the input method of the authentication information 210, the hidden security request 211 can be determined by facial recognition (or iris recognition). For example, the user can perform a predetermined gesture (e.g., blinking of the eyes, a hand movement, a shoulder movement, etc.), can perform a predetermined movement (e.g., moving the lips, moving the head in a given direction/sequence, inflating the jaws, etc.), etc.

When biometric authentication is the input method of the authentication information 210, the hidden security request 211 can be determined by the gait of the user. For example, the user can walk faster/slower than normal, the user can jump, the user can walk a sequence of short/long steps, etc.

When a password/pin is the input method of the authentication information 210, the hidden security request 211 can be determined by a predetermined input by the user. For example, the user can input a different password/pin than the normal password/pin, the user can input a predetermined number(s), letter(s), etc., appended to the beginning and/or ending of the normal password/pin, etc.

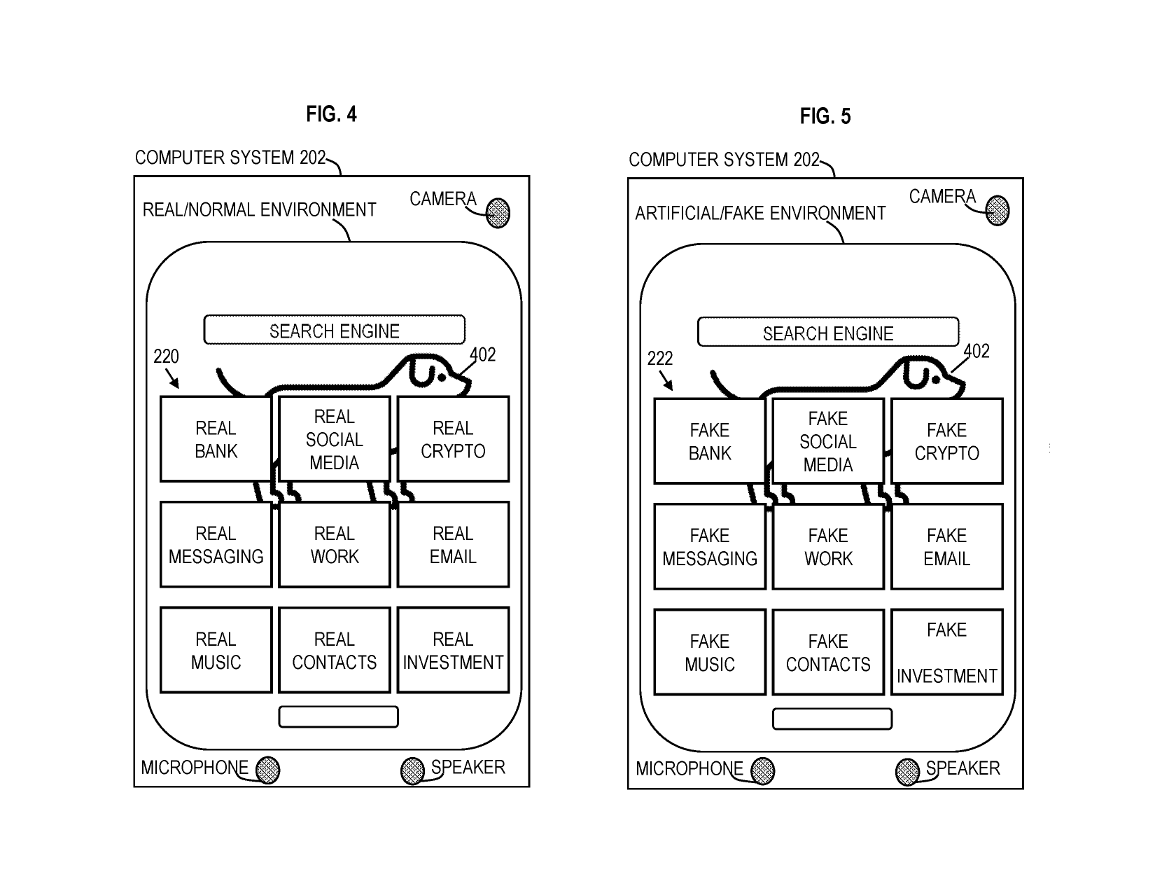

At blocks 308 and 310, when no hidden security request is made, the software 204 of the computer system 202 is configured to continue with normal authentication for the user to access the computer system 202 and present a real/normal operating environment for user interaction on the computer system 202. An example real/normal operating environment with real applications (apps) 220 is depicted in FIG. 4. The real/normal applications 220 operate in a normal manner to provide services. In FIG. 4, the real/normal applications 220 can connect to the computer systems 240 for various online services requiring the use of real user data in the repository 280.

At blocks 312, 314, and 316, when the hidden security request information is found in the authentication information 210, the software 204 of the computer system 202 is configured to determine/select an artificial/fake operating environment, load/create artificial/fake data 282 (e.g., all and/or part of the artificial/fake data 282 may be created/stored in advance), and execute the artificial/fake operating environment for presentation on the computer system 202. The software 204 may include, call, and/or integrate the mobile security system 208 for executing security services. The artificial/fake operating environment can be chosen from a repository 270 of artificial/fake operating environments. An example artificial/fake operating environment with artificial/fake applications (apps) 222 is depicted in FIG. 5. In FIG. 5, the artificial/fake operating environment can use artificial/fake data 282 with artificial/fake applications 222 in order to prevent the unauthorized user from accessing personal information of the user.

Once the mobile security system 208 is executed (e.g., by identifying the hidden security request 211 as an execution command), the mobile security system 208 may select a default artificial/fake operating environment and/or may select an associated artificial/fake operating environment to be deployed based on the execution command received. In some cases, the user selects an associated artificial/fake operating environment in accordance with the method the user utilizes to specifically input the hidden security request 211. For example, when the user inputs the hidden security request 211 by blinking, the mobile security system 208 executes an associated artificial/fake operating environment A. When the user inputs the hidden security request 211 by a first gesture, the mobile security system 208 executes an associated artificial/fake operating environment B. When the user inputs the hidden security request 211 with a password/pin, the mobile security system 208 executes an associated artificial/fake operating environment C, and so forth.

The mobile security system 208 can be configured to execute with root permissions. In one or more embodiments, the artificial/fake operating environment can be loaded as a virtual machine that is executed on top of the operating system to simulate that the artificial/fake operating environment is the real operating system to the unauthorized user. In one or more embodiments, the artificial/fake operating environment can be loaded on a different partition, and then once the authentication is executed the operating system is restarted to then bootup using the artificial/fake operating environment on the selected partition. In one or more embodiments, the artificial/fake operating environment can be loaded as a super app on top of the operating system. In this case, the super app simulates the operating system and prevents any attempt to escape the super app. The only escape is rebooting; however, after the reboot, the user has to authenticate again, and therefore the system/data (including user data of repository 280) remains secure.

There can be a set of different types of artificial/fake operating environments in the repository 270 from which the user can select in advance. In one or more embodiments, the user can input a predetermined hidden security request 211 that is associated with a predetermined one of the artificial/fake operating environment in the repository 270, where blinking is associated with artificial/fake operating environment A or where a first gesture is associated with artificial/fake operating environment B. The following are examples of artificial/fake operating environments:

1) A copy of the real environment with the same apps but with different data. For example, FIG. 5 depicts the artificial/fake operating environment with the same named/type/number of apps as the real/normal operating environment in FIG. 4, except the fake/normal operating environment has artificial/fake applications 222 that use artificial/fake data 282 instead of real user data of repository 280. Having the same apps means that the artificial/fake operating environment has the same artificial/fake apps as the real/normal apps in the real/normal operating environment, but the artificial/fake apps do not connect to the network 250 for connection to computer systems 240; likewise, the artificial/fake apps visually appear functional but provide false results. In some cases, the artificial/fake apps may be designed to generate an error, making the unauthorized user believe that there is a malfunction. By being a copy of the real environment, the artificial/fake operating environment can have the same name, number, and/or appearance for the artificial/fake apps 222 as the real/normal apps 220 in the real/normal operating environment. Because the real/normal operating environment has ABC real bank app, XYZ real social media app, JKL real crypto app, etc., the artificial/fake operating environment similarly has ABC fake bank app, XYZ fake social media app, JKL fake crypto app, etc., thereby mimicking the real/normal operating environment. Additionally, both the real/normal operating environment and the artificial/fake operating environment display the same background object 402 in FIGS. 4 and 5, which is depicted as a graphical image. Moreover, being a copy of the real environment means that the both the real/normal operating environment and the artificial/fake operating environment are displayed to the unauthorized user with the same color scheme, same arrangement (and/or number) of apps (e.g., artificial/fake apps are arranged identically to the corresponding real/normal apps), same widgets, same arrangement of widgets, same clock style/position, same personalization, etc.

2) A copy of the real environment with different apps and different data. In this case, the artificial/fake operating environment can be generated to have different apps, where the real/normal operating environment has ABC real bank app but the artificial/fake operating environment has XYZ fake bank app. The artificial/fake operating environment may be similar to the example in FIG. 5 but does not have the same type of applications.

3) A different environment with the same apps but with different data. In this case, the appearance of the artificial/fake operating environment can be different (e.g., different background) but the apps are the same, which means the real/normal environment has ABC real bank app and the artificial/fake operating environment has ABC fake bank app. The artificial/fake operating environment may be similar to the example in FIG. 5 but does not have, for example, the same background object 402.

4) A different environment with different apps and different data. In this case, the appearance of the artificial/fake operating environment and the artificial/fake apps are different.

5) A customized environment designed by the user with data and apps selected by the user. In this case, the user selects the design of the artificial/fake operating environment including the artificial/fake apps 222, the artificial/fake data 282, arrangement of the artificial/fake apps 222, etc.

Regarding the generation of artificial/fake data 282, the software 204 can employ a generative AI model 242 to create artificial/fake data 282 to replace the original (real) user data of repository 280. The generative AI model 242 can be instructed to create the artificial/date data 282. The generation of the artificial/fake data 282 can be performed using any of the following categories:

1) Generic generation of data. Random data can be utilized for the artificial/fake data 282.

2) Generation of data based on user characteristics. Data is generated that refers to the user in order to deceive the unauthorized user. For example, when the user characteristics on the computer system 202 identify that the user works at HIJ company, artificial/fake data 282 is generated for the HIJ company.

3) Generation of data based on other characteristics such as device, time, location, etc.

4) Generation of data based on user inputs.

Regarding the functionality of the artificial/fake operating environment, the software 204 can provide the following options:

1) Apps work normally. The artificial/fake apps 222 replicate the functionality of the real/normal apps 220 but use the artificial/fake data 282.

2) Apps process the data locally but without sending data over the network 250 (e.g., showing an error). In one or more embodiments, the artificial/fake apps 222 can simulate a transaction without sending data and return an error to the unauthorized user. In one or more embodiments, the real/normal apps 220 can be utilized in which a transaction is attempted but the software 204 (e.g., a network filter) blocks any data from leaving the computer system 202 to reach the network 250. Therefore, the computer system 202 is blocked from sending out data over the network 250 and/or blocked from connecting to the network 250, although it appears to the unauthorized user that the applications of the computer system 202 are connected to the network 250.

3) Apps process the data locally but without sending data over the network 250 (e.g., showing no error). In this case, the artificial/fake apps 222 can simulate a successful transaction without sending data, and no error is returned to the unauthorized user.

4) Apps do not execute and show a system error. For example, the operating system does not boot and shows an error such as, for example, a missing driver, hardware error, blue screen, etc. For example, when the unauthorized user opens the fake bank app (or the real bank app), the artificial/fake operating system reboots and displays an error.

Referring to FIG. 3, at block 318, the software 204 of the computer system 202 is configured to check whether an escape command is received from the user. At block 320, when the escape command is received, the software 204 exits the artificial/fake operating environment. When the escape command is not received, the flow continues to execute the artificial/fake operating environment.

There are numerous methods to exit the artificial/fake operating environment. In one or more embodiments, the user can by using an exit key combination, which may include pressing/selecting some keys in a predefined combination. In one or more embodiments, device sensors of the computer system 202 can be utilized to exit the artificial/fake operating environment. For example, the software 204 can receive and recognize the inputs like tapping, rotating, touching, etc., from sensors on the computer system 202. Example sensors can include accelerometers, capacitive sensors, inductive sensors, global positioning system (GPS) sensors, etc.

In one or more embodiments, geolocation can be utilized as a condition to exit the artificial/fake operating environment. For example, any of the previous methods to exit the artificial/fake operating environment can be utilized in combination with a rule that the device is to be located in a given place such as, for example, at home, at work, in the car (e.g., connected wirelessly), at the police station, etc.

In one or more embodiments, device factors can be utilized as a condition to exit the artificial/fake operating environment. For example, any of the previous methods to exit the artificial/fake operating environment can be utilized in combination with a validation to the device (e.g., computer system 202), where something (e.g., a connection) is to be validated on the device. For example, validation can occur by the device connecting to a given Internet of things (IoT) or a wearable device, connecting to a given network (e.g., home network), etc.

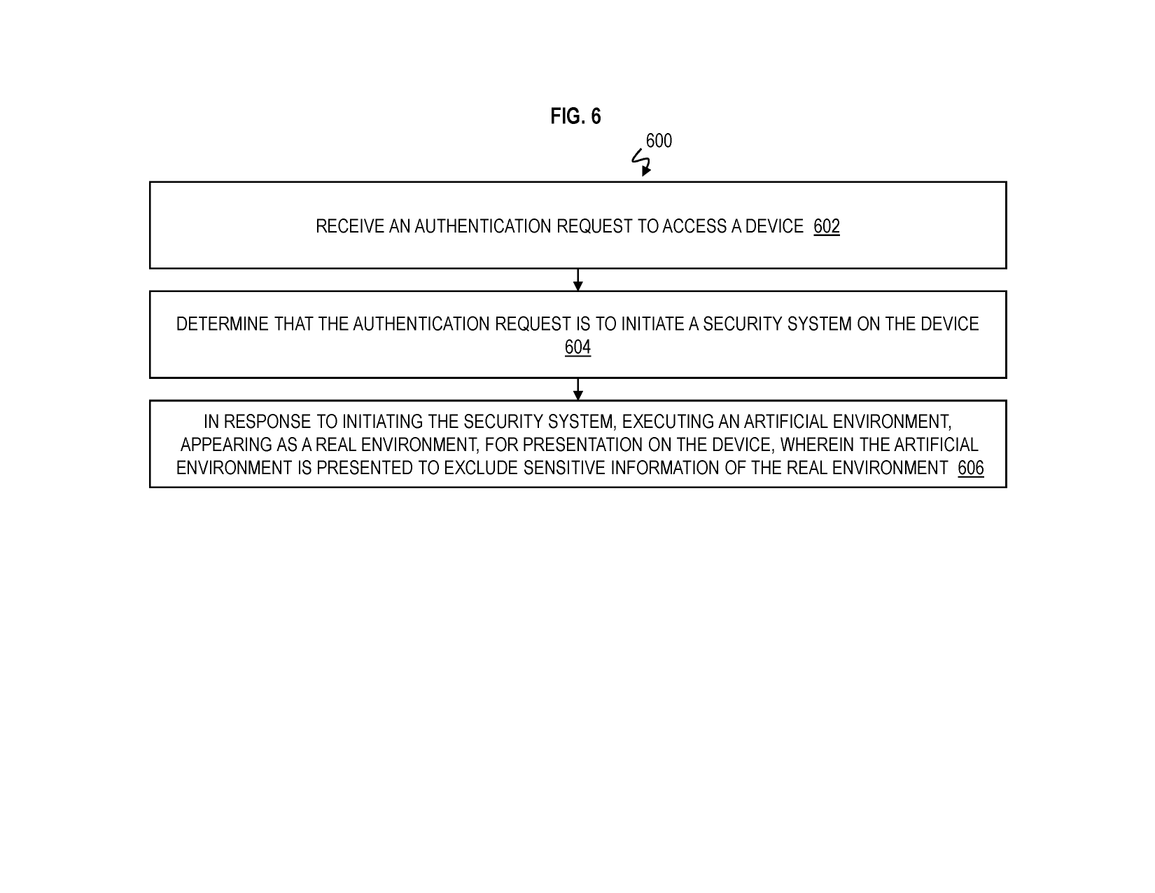

FIG. 6 is a flowchart of a computer-implemented method 600 for executing smart deployment of a honeypot environment on personal devices for security in accordance with one or more embodiments. Reference can be made to any figures. At block 602, the computer system 202 receives an authentication request (e.g., authentication information 210) to access a device (e.g., computer system 202). For example, the device is locked, and authentication is required. At block 604, the computer system 202 determines that the authentication request is to initiate a security system (e.g., mobile security system 208) on the device. At block 606, the computer system 202, in response to initiating the security system (e.g., mobile security system 208), executes an artificial environment (e.g., artificial/fake operating environment in FIG. 4), appearing as a real environment (e.g., real/normal operating environment in FIG. 5), for presentation on the device, wherein the artificial environment is presented to exclude sensitive information (e.g., user data in repository 280) of the real environment.

Further, the authentication request (e.g., authentication information 210) is a biometric authentication. The determining that the authentication request (e.g., authentication information 210) is to initiate the security system on the device includes identifying that a security request (e.g., a hidden security request 211) occurred during fingerprint recognition. The determining that the authentication request is to initiate the security system on the device includes identifying that a security request (e.g., a hidden security request 211) occurred during facial recognition. The determining that the authentication request is to initiate the security system on the device includes identifying that a security request occurred during gesture recognition.

The artificial environment is a copy of the same type of applications in the real environment but with different data for the same applications (e.g., as depicted in FIG. 5); the artificial environment is a copy of the real environment with different applications and with the different data for the different applications; the artificial environment is a different environment from the real environment with the same type of applications and with the different data for the applications; the artificial environment is a different environment from the real environment with the different applications and with the different data for the different applications; or the artificial environment is a customized environment designed by an owner of the device. The authentication request is received using one or more sensors (e.g., input devices 212 including microphone, camera, fingerprint/biometric scanner, touch screen, keypad, etc.) of the device.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

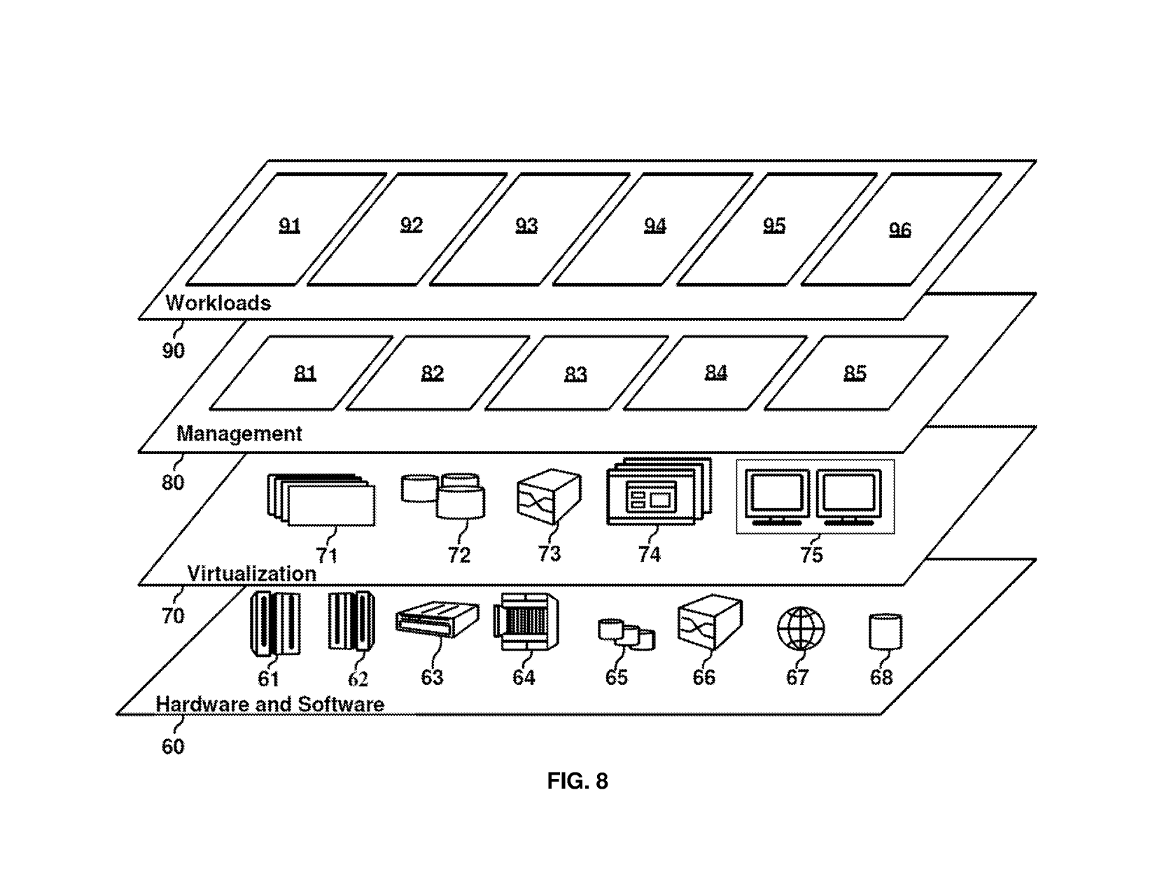

Referring now to FIG. 8, a set of functional abstraction layers provided by cloud computing environment 50 (depicted in FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the generative AI model 242, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purpose of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving an authentication request to access a device;
determining that the authentication request is to initiate a security system on the device; and
in response to initiating the security system, executing an artificial environment, appearing as a real environment, for presentation on the device, wherein the artificial environment is presented to exclude sensitive information of the real environment.

2. The computer-implemented method of claim 1, wherein the authentication request is a biometric authentication.

3. The computer-implemented method of claim 1, wherein the determining that the authentication request is to initiate the security system on the device comprises identifying that a security request occurred during fingerprint recognition.

4. The computer-implemented method of claim 1, wherein the determining that the authentication request is to initiate the security system on the device comprises identifying that a security request occurred during facial recognition.

5. The computer-implemented method of claim 1, wherein the determining that the authentication request is to initiate the security system on the device comprises identifying that a security request occurred during gesture recognition.

6. The computer-implemented method of claim 1, wherein:
the artificial environment is a copy of a type of applications in the real environment but with different data for the applications;
the artificial environment is a copy of the real environment with different applications and with the different data for the different applications;
the artificial environment is a different environment from the real environment with the applications and with the different data for the applications;
the artificial environment is a different environment from the real environment with the different applications and with the different data for the different applications; or
the artificial environment is a customized environment designed by an owner of the device.

7. The computer-implemented method of claim 1, wherein the authentication request is received using one or more sensors of the device.

8. A device comprising:
a memory having computer readable instructions; and
one or more processors for executing the computer readable instructions, the computer readable instructions when executed cause the one or more processors to perform operations comprising:
receiving an authentication request to access the device;
determining that the authentication request is to initiate a security system on the device; and
in response to initiating the security system, executing an artificial environment, appearing as a real environment, for presentation on the device, wherein the artificial environment is presented to exclude sensitive information of the real environment.

9. The device of claim 8, wherein the authentication request is a biometric authentication.

10. The device of claim 8, wherein the determining that the authentication request is to initiate the security system on the device comprises identifying that a security request occurred during fingerprint recognition.

11. The device of claim 8, wherein the determining that the authentication request is to initiate the security system on the device comprises identifying that a security request occurred during facial recognition.

12. The device of claim 8, wherein the determining that the authentication request is to initiate the security system on the device comprises identifying that a security request occurred during gesture recognition.

13. The device of claim 8, wherein:
the artificial environment is a copy of a type of applications in the real environment but with different data for the applications;
the artificial environment is a copy of the real environment with different applications and with the different data for the different applications;
the artificial environment is a different environment from the real environment with the applications and with the different data for the applications;
the artificial environment is a different environment from the real environment with the different applications and with the different data for the different applications; or
the artificial environment is a customized environment designed by an owner of the device.

14. The device of claim 8, wherein the authentication request is received using one or more sensors of the device.

15. A computer program product comprising a computer readable storage medium having program instructions embodied therewith, the program instructions executable by one or more processors to cause the one or more processors to perform operations comprising:
receiving an authentication request to access a device;
determining that the authentication request is to initiate a security system on the device; and
in response to initiating the security system, executing an artificial environment, appearing as a real environment, for presentation on the device, wherein the artificial environment is presented to exclude sensitive information of the real environment.

16. The computer program product of claim 15, wherein the authentication request is a biometric authentication.

17. The computer program product of claim 15, wherein the determining that the authentication request is to initiate the security system on the device comprises identifying that a security request occurred during fingerprint recognition.

18. The computer program product of claim 15, wherein the determining that the authentication request is to initiate the security system on the device comprises identifying that a security request occurred during facial recognition.

19. The computer program product of claim 15, wherein the determining that the authentication request is to initiate the security system on the device comprises identifying that a security request occurred during gesture recognition.

20. The computer program product of claim 15, wherein:
the artificial environment is a copy of a type of applications in the real environment but with different data for the applications;
the artificial environment is a copy of the real environment with different applications and with the different data for the different applications;
the artificial environment is a different environment from the real environment with the applications and with the different data for the applications;
the artificial environment is a different environment from the real environment with the different applications and with the different data for the different applications; or
the artificial environment is a customized environment designed by an owner of the device.
